(19) United States
(12) Patent Application Publication
(10) Pub. No.: US 2016/0232502 A1
(43) Pub. Date: Aug. 11, 2016

(54) SYSTEM AND METHOD FOR INTER PARTY TRANSACTIONS USING A PLUG-IN MODULE TO A SERVICE

(71) Applicant: Alpine Audio Now, LLC, Reston, VA (US)

(72) Inventors: Marcel BARBULESCU, Falls Church, VA (US); Eugen LEONTIE, Fort Washington, MD (US); Elan Joel BLUTINGER, Washington, DC (US); Rebecca WALKER, Washington, DC (US)

(73) Assignee: Alpine Audio Now, LLC

(21) Appl. No.: 14/687,209

(22) Filed: Apr. 15, 2015

Related U.S. Application Data
(60) Provisional application No. 62/113,781, filed on Feb. 9, 2015.

(51) Int. Cl. G06Q 20/10; H04L 12/58

(52) U.S. Cl. CPC G06Q 20/108; H04L 51/32; G06Q 50/04

(57) ABSTRACT

Disclosed herein are systems, methods, and computer-readable storage media for providing a plug-in to an application, such as an audio delivery application, which enables an entity to utilize data about the ecosystem of users in the application and present offers or notices through the application. The offers enable users of the application to engage perform a transaction such as make a donation or transaction or communicate with other users within a community of users that are registered with the application.

### PRIORITY CLAIM

This application claims priority to U.S. Provisional Patent Application No. 62/113,781 filed on 9 Feb. 2015, which is herein incorporated by reference in its entirety.

### BACKGROUND

1. Technical Field

The present disclosure relates to providing a plug-in to an application such as an audio service. Having the plug-in enables additional functionality to be combined with the application. The example audio service enables end users in a community of end users to utilize a telephone or other device to access streaming audio. The plug-in provides a user of the audio service to engage in a transaction with another user of the community, where the community is defined at some level as a group of users of the application or service.

2. Introduction

Companies such as Western Union handle money transfers from the United States to multiple countries around the world via agents. The typical scenario is that someone walks into an agent at a CVS or Walmart with cash for a relative abroad. The money goes through the network and that is delivered to the designee abroad through a local agent.

However, this approach is somewhat cumbersome as users need to use the particular system and to go to a particular place. Further, users may have to go through a number of steps to work through the process of identifying the recipient, choosing the amount of money, and completing the transaction.

The same issue applies to many different types of transactions between individuals. In many cases, services that people would like to utilize are compartmentalized and offered by different entities thus requiring people to transition from one application/entity to another for performing the transactions or functions they desire. The current approaches of requiring users to transition between entities may be too difficult or time consuming to complete.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for providing a plug-in to an application. The plug-in enables an entity outside of the application to tap into an “eco-system” defined by the application and its community of users. The application can perform any function. For example, the application might be an audio or video streaming application, taxi ordering application such as Uber, social media application or any other type of application. Each application will have users that form a community of users. The concepts disclosed herein focus on a plug-in or addition to such an application or service that provides an additional functionality to provide opportunities for people that use the application to engage in some kind of transaction.

One example application that will be used throughout the disclosure is a service that provides streaming audio to devices. This is not meant however to limit the scope of the claims to such a system except where such feature is specifically claimed. Any application could apply. This disclosure addresses a specific problem in the current state of the art where individual users of an application may desire to perform a function or a transaction with others in a community of users of the application, but in order to do so, the user must exit the application and start up or go to a completely separate entity. The concepts disclosed herein address this technical problem.

Assume in the example that a system connects end user devices to streaming audio. In the example system, an application or service is provided that enables user devices to connect to streaming audio either via a telephone call, a data connection or a wireless connection such as a standard RF signal. In this or any such application, a community of users will develop. These are users that of course take advantage of the service. The application will also develop and store data about its community that can be useful for various other functions that are normally offered by separate entities. This disclosure explains how plug-ins to an application can enable the blending of different types of functions into essentially one service or one application.

In a streaming audio scenario, the community can be identified either as all users or users of a particular portion of the service. For example, if the service provides streaming audio of an English radio station and a Spanish speaking radio station, then two communities of users within the application can be identified based on the language of the stations. Communities could also be identified based on location of the radio station broadcast or subject matter, or any number of factors. The application or system also then can obtain or have access to user data about interests, timing of listening patterns, location-based information, and so forth. The application will gather and have available for beneficial purposes, such information. In this disclosure, the concept involves using such information about the users to enable other businesses or entities to include a plug-in to the service that enhances that entities ability to utilize the information about the users and provide abilities to have the users engage in transactions with each other or with businesses essentially through the application, rather than jumping to another application, website, etc. to perform the function.

The system could also provide different services. One example service is a money transfer between different users in the community. The context of the present disclosure is that the system defines a community of people. For example, assume that an application on a mobile device provides streaming audio to Spanish-speaking radio stations. All of the users the application in general or just those users that listen to the Spanish-speaking radio station can define a community of users. The advantage of the present disclosure is a module or a plug-in that can enable transactions to occur amongst the community of users. In the example plug-in mentioned, a money transfer could be performed from one user who listens to a Spanish radio station to another user who also listens to the Spanish radio station.

Any kind of transaction could occur such as just transmitting a simple message, selling an item from one communication member to another, to transferring money, points, goods, data, permissions, or authority, performing a purchase of an item through the plug-in, and so forth. Where a money transfer is the transaction, or points, rewards, or other fungible item, the benefit is transferred via a withdrawal from a giver account and a placement in a recipient account.

A system implementing the method can provide an additional feature to an audio streaming application that can enable an end user to send money from their account to another account within the community of users, however that community is defined.

### BRIEF DESCRIPTION OF THE DRAWINGS

FIG. 1 illustrates an example system embodiment;

FIG. 2 illustrates an example plug in to an application; and

FIG. 3 illustrates an example method.

### DETAILED DESCRIPTION

Various examples are provided below that are helpful for understanding the claims. While specific implementations are described, it should be understood that this is done for illustration purposes only. Other components and configurations may be used without parting from the spirit and scope of the disclosure. The disclosure will first introduce the basic hardware components that will apply and then proceed to discuss the details.

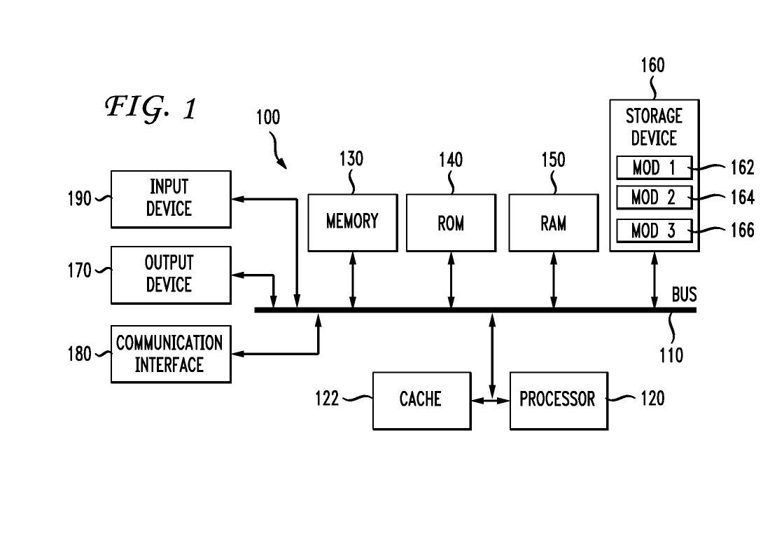

A brief introductory description of a basic general-purpose system or computing device in FIG. 1 that can be employed to practice the concepts is disclosed herein. A more detailed description of video and secondary audio source synchronization will then follow. The disclosure now turns to FIG. 1.

With reference to FIG. 1, an exemplary system 100 includes a computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

Having disclosed the basic hardware components associated with the concepts disclosed herein, the disclosure now turns to the more specific details about the plug-in feature that enables users in a community of users of a particular application to perform transactions between each other. Further, the plug-in could also perform other functionality offered by a business or entity that does not require a particular transaction with another user of the community.

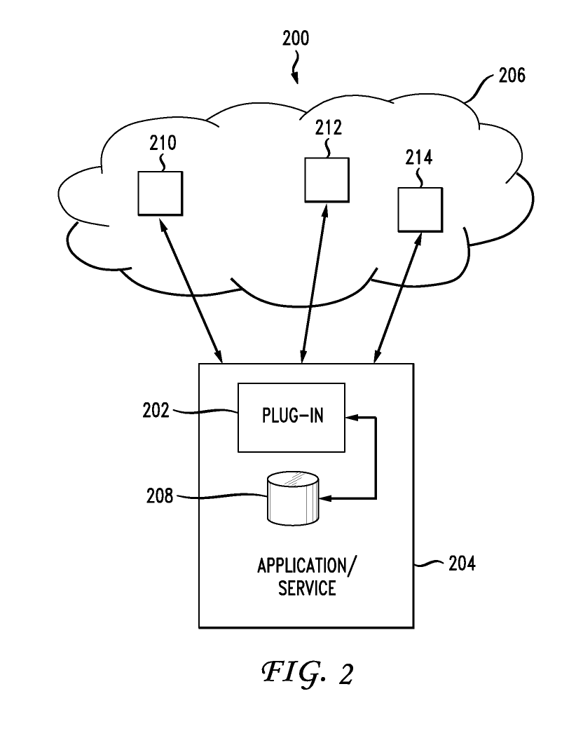

A system, method and computer-readable media are disclosed which provide a plug-in to a application or a service which provide the functionality from within that application to enable a transaction between one user of the application/service and another user of the application. FIG. 2 generally illustrates the concept 200 of the plug-in 202 that is added as part of an overall service 204 that serves a community of users 206. The service 204 includes a database 208 of information about the users in the community. In general, the concepts disclosed herein enable the service 204 to engage with a first user 210 about a possible transaction. In one aspect that could include interacting with a second user 212 in the community of users.

One example of the transaction can be that one user can transfer money to another user, although any transaction is contemplated as within the scope of this disclosure. It is noted that part of the disclosure could be what data is available for advertisements or the presentation of offers or possibilities for an interaction between users from plug-in entities. Advertisers and businesses can have access to user data associated with the application (locations, countries, cultures, user preferences, likely goods and services such as airlines servicing a country, products preferred in certain areas, social networking information, family information, and so forth). Such data could be made available from the application “eco-system” via a standardized format or via an application programming interface (API) that other entities developing plug-ins could tap in to. In this regard, one component of the disclosure relates to the unique knowledge that the application can have of the members of the community.

For example, a community of 50,000 users might be defined as those who listen to a particular Haiti radio station. Assume that one of those users is in New York and has family back in Haiti. The system, utilizing one or more pieces of data about the users in the community, can provide that data to an entity having a plug-in to the system application. The data might cause the system to present an advertisement or offering to the user in New York to send money to a family member or member of the community. The choice of what advertisement to send could be based on a selection of one plug-in having its particular functionality over another plug-in. Thus, if the data determines that the appropriate subject matter for an offering is a money transfer, then the money-transfer plug-in could be selected, and that plug-in is allowed to present its offering via the user interface of the application.

If the user accepts the offer or engages in an interaction with the presentation from the plug-in, then the user can continue through the process of selecting a recipient for the interaction and confirming the transaction. In the case of sending money, of course the amount would be chosen and via the application, the giver's account could have a withdrawal of money that would be deposited in the recipient account. This transaction would be handled and processed within the application rather than exiting the application and going to a different application or website to perform the money transfer. Part of the benefit of the concepts disclosed herein is the ability to keep the transaction as part of the application and thus efficiency, branding, etc. are all enhanced for the community of users.

In another example, transactions can occur between different users in a community of users defined by registration with the application or service. The streaming audio application described above can connect callers to a telephone number to streaming audio. The various users of the system can be organized into communities. The community organization can be based on particular stations they listen to and/or, for example, geography or language. Thus, all those that listen to Spanish or Haitian stations are defined as part of a community. The community could be all those between the age of 19-30 that listen to Haitian language stations. Any structure or definition of the community can apply. The radio streaming application could present an option for a user to transfer money to another person in the community. The advertisement can be tailored based on the unique characteristics of the application and the community.

Again, the service also can be any service. The concepts disclosed herein could apply to services such as YouTube™, a news website, a blog, an email application, Facebook®, Twirter®, a video game, etc. The general concept is taking an existing application or service, with the various pieces of data that are obtained through the community of users interacting with the system, and enabling other businesses or services to include a plug-in or software/hardware module that can receive information or data from the service and provide the ability of users within the community to engage in interactions or transactions together without leaving the application. The data can be provided in a standardized format via an API such that different plug-ins can tap into and utilize the particular data they desire for performing their function that is separate from the application/service. The functionality also may not even be a plug-in but built in technology that enables the separate functionality to be performed within the application. Thus, the particular function of the plug-in could vary to be any functionality. Facebook® could have a plug in that enables the user to perform a Facebook transaction such as a message from one user to another. For example, the service may know that two friends are both listening to the same soccer game and present an option for one friend to message another using the Facebook message plug-in feature in the service.

The following is a further variation on the examples provided above. Assume that an application provides access to a Haitian language radio station and is accessed by many users in Haiti. One person in the community, say whose name is John, might be traveling to another location such as the United States and use the application to access the Haitian language content. Based on any number of factors, such as a location-based parameter, current news, identification of money in someone's account, other people within the community that are listening simultaneously to a station, or any other factors, the system may determine to present an option to the user in the United States to send money back to another user in the community (who of course could be a family member or a friend) in Haiti. The system, knowing any one or more of the following parameters: the family relationship, friend relationship, time of day, listening habits, who is on the system, etc. can present the option to the U.S. based user as follows: “John, you could send $10 to Mary via a money transfer. She is now listening to Haitian Radio 1. Click here to accomplish the transfer.” When John clicks on or interacts with that offer, then the plug-in proceeds to perform the function defined by the plug-in. The money would then be transferred from John's account to Mary's account.

In another example, if there is a large event such as an earthquake or hurricane in Haiti, then the system could be used for people to donate to a disaster fund. The interest level would be defined by virtue of the community of users having an interest in Haiti. In this regards, the transaction is not directly done between one user and another but is a transaction (a donation) that relates to the community or is of interest to the community.

In this manner, the system can provide a mechanism of interacting for or amongst a particular community. Multiple layered communities can exist as well. For example, a close community might be those listening to a particular station, while a broader community could be all listeners to all stations of a particular language. The interactions or advertisements can be based on what hierarchical level of community the person you want to interact with is relative to the initiator of the interaction. The community can be divided into hierarchical layers or levels to narrowly define the community. One layer could be all members 18-30 who interact with the application in some way and the broader layer could be all members who interact with the application. Various sub-communities could be defined also not in a hierarchical fashion but based on other factors such as location, purchasing history, timing of when they interact with the application, and so forth. The community could be defined in any number of ways to help to improve or tailor how people can interact or have services offered.

Having disclosed some components of a computing system, the disclosure now turns to further examples of the concepts including additional concepts associated with money transfers. Usually, there is a charge for a money transfer or a charge for performing the transaction. The system in this case could vary the charge for the transaction based on some parameter such as how close the recipient is to the giver in the community. The user could be able to perform the transaction for free if the listener views or listens to advertisements. In some cases, the more the users use the system, the more money the entity running the system makes. Thus, one parameter that can be related to how much the user gets charged for a transaction is the number of minutes that one of the first user and the second user use the system. The charge for the transaction could also be based on how many points a user has on the system. If the system operates a game, for example, the amount of points, success and/or time, or any other factor, can have bearing on how much a user is charged for a transaction associated with or between users in the community.

In another example, the application could be a combined single application of an audio system and a financial transaction system. As a “plug in,” a vendor, such as Western Union or any other financial services vendor, could be given an SDK (Software developer toolkit). The vendor is then given access to the audio system “eco-system” of media apps including the broadcasters and the listeners. The preferred approach is modular in that the third party vendors could have a chance to plug into the existing audio system application with a listener base and a media partner. The fact that this approach can be done with a remittance/money transfer company is one component but having any type of business have their own plug-in and functionality is also another aspect of this disclosure. So who the business partner is that can plug into the app is somewhat secondary.

This “plug in” approach allowing third parties, in this case a money transfer company and other businesses, to have access to the ecosystem will let advertisers or businesses select criteria for serving up offers (where an money transfer agent is located, what agent is best qualified to handle a transfer to a particular country, what airline flies to the likely country you want to travel to, etc) based on the language and or ethnicity and location of the listener. This disclosure provides an entirely new approach that combines a modular approach to participating in an existing ecosystem of the unique makeup of mobile listeners and broadcasters based on the unique qualities of the content which identifies a likely listener while harnessing the power inherent in mobile devices. There are additional security and validation advantages which these factors provide. As more plug-ins are added to the system, an algorithm that utilizes data from the eco-system and makes a determination of what kind of offer to present can be updated to include characteristics of that new plug-in relative to the other plug-ins available on the service.

The audio system example includes an application or just a telephone that connects to a server in which the server receives streaming audio over the Internet from a website or other source. The end users connect via an application or a telephone call. The audio system has user profile data which can be very useful for businesses to tap into. Given the various types of businesses available, the audio system can be configured such that different businesses can each have a plug in with the particular functionality. For example, some business could tap into the ecosystem and provide advertisements. One business could provide money transfers, while others might make offers to sell goods or services for purchase via an Amazon.com type “one-click” purchase. Another business may provide a social networking ability for users in the community to more easily connect with each other on Facebook®.

What makes this approach unique is not just the remittance functionality, but the fact that the third party application plugs into the existing application (such as the broadcasting (radio and TV) application) and can assess the financial/business services available for certain markets based on the language and ethnicity of the broadcast, the location of the sender/listener and additionally, the location of the recipient. The factors that can be considered in an automated decision to present an offering via the plug-in to the audio system can include one or more of the following factors: the ethnicity of the broadcast, a profile of the listener, a purchasing history of the listener, aggregated data on the group of listeners, a time (such as when individual users are interacting with the system, or a predetermined period of time after a user stops using the system), available inventory of products, etc. The available services can be automatic or coded manually. The services would vary depending on what's being offered; it could include remittances, financial transfers, as well as top up (purchasing airtime), paying bills at home or abroad, and money transfer agent referrals, based on the ethnicity, locations and language of the content. The geolocation of the mobile device of the sender and the content of the broadcast can assist in security algorithms and determine the validity and verification of the sender.

Depending on the destination and location of the receiving person's country, and for the sender, the content of the broadcast, the service could provide multiple options including locations for receiving and sending money or its equivalent. The functionality of the application would be directly connected to pre-existing mobile apps and not just standalone.

Two pieces are part of this disclosure. The audio system serves up information on the listeners in its system and provides the data via a software developer kit (SDK) and/or an application programming interface (API) to other entities such as commerce companies. For example, a money transfer company that does remittances or topping up a phone bill in another country, can utilize the SDK to receive data and provide targeted offers via the audio system application. The system can identify a demographic match of the sender and/or the recipient if remittance is the service. The system can geo-locate based on features of the caller to identify the caller and their characteristics. This allows targeted of advertisements/services, initiating a commercial transaction or some other functionality. If a person, for example, is in New York but from Guatemala, then that information can be used to target an advertisement. So there is a possibility that if the person in New York wants to do a transaction, it might be back to Guatemala. Based on content of call, etc. the system can provide offers and connect services that might relate to companies or people back in the home country of the user. The concept is to create an ecosystem of plug-ins that allows any company selling any item or service, such as movie tickets, can link into the multimedia system app, and obtain the necessary data, linguistic, content of broadcasts heard, etc. for each user. Likely ethnicity of the caller who is using the app can be important information.

A difference between the experience of user interacting with a user interface of the plug-in to the application is that the plug-in can include a full user interface that when called up by a user via the application, enables the user to fill in forms, select other users, input data, confirm transactions, etc., all within the plug-in functionality. The user is not taken from the domain of the application to a completely separate domain of an advertiser as in a normal banner type advertisement. Each plug-in from each different entity will have its full blown user interface that will be running within the application.

Again, assume the person is in New York but listening to a Guatemalan broadcast. The location of the origination of the broadcast could also drive different offers. The broadcast might originate from New York or might be physically from Guatemala. If the broadcast originates from New York, the system might offer Spanish content for a theater in New York. Thus, the data available about the physical originating location of the broadcast can provide a better targeting for services. The platform is designed to accommodate plug-in applications through the SDK to provide an API. For example, one available option for a user of the Audio/Media application could be “send money home.” A service option in the audio system will be connected to a Western Union type company. When the user clicks on an ad in an application, usually the user is taken to the other website. When the user wants to do a remittance, using the plug-in, all the processing is done within the application. The entire user interface including various screens and data fields for inputting data are contained within the plug-in. In some cases, the system can send some data out to the service provider over a network to accomplish some or part of the transaction. However, the user is interacting with the application, and the application performs some or all of the processing to accomplish the transaction, particularly if it is between users in the community. The system can also tap into listener social media data to identify people within their social group. Streaming multimedia application that uses the listener information to provide an infrastructure to allow other commerce provides to plug to an SDK.

In one example of handling money transfers, the SDK will have the necessary standardized protocols which can handle, one the user inputs the necessary data to identify the giver and the recipient and the amount of money, via the SDK/API, the system can output instructions for a particular transaction to take place. John Doe wants to give $50 to Jane Doe. The application via the SDK/API then can have a defined interface that reports back that the money was paid. The plug-in can then handle all of the user interface and data input for managing the transaction and any aftermath communication. In one case, the SDK/API can communicate data from the plug-in based on information held by the application. For example, if the application stores customer payment accounts, addresses, and so forth, the SDK/API may receive an instruction to transfer money from a first customer to a second customer, the application can carry out some or all of that transaction by virtue of its storing the payment account information.

In the remittance example. Assume a user wants to send money to their aunt in Guatemala. Usually, the person contacts the aunt and says I am sending money to Western Union. With this plug-in, the user can communicate that directly. In the application, with the plug-in, remittance company or the media application will be able to communicate with people already on the system, if she is already in the system. An icon or an advertisement or data associated with a specific plug-in of a plurality of plug-ins can be displayed based on an analysis of the various parameters disclosed herein such as user demographics, purchasing history, etc. Thus, another difference in this approach from other approaches is that the system presents data associated with a selected plug-in that matches the user's likely interests.

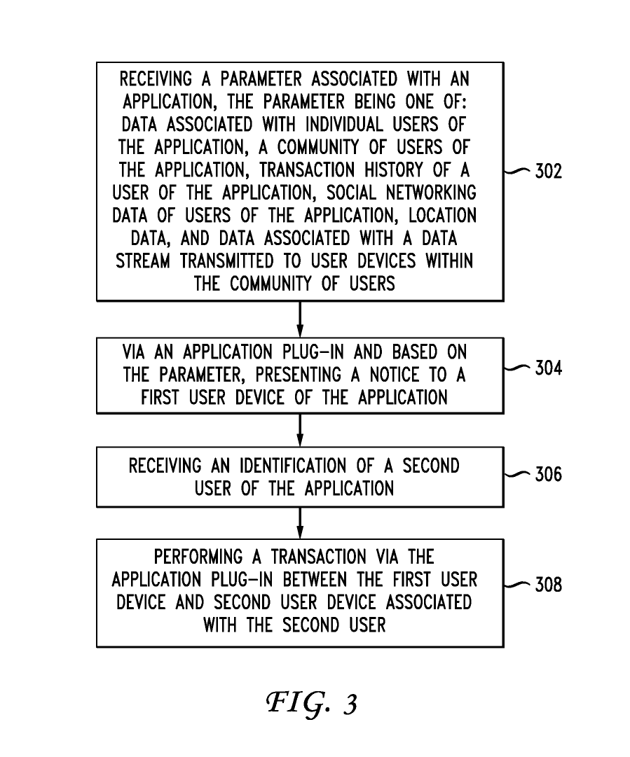

FIG. 3 illustrates an example method of this disclosure. A method includes receiving a parameter associated with an application, the parameter being one of: data associated with individual users of the application, a community of users of the application, transaction history of a user of the application, social networking data of users of the application, location data, and data associated with a data stream transmitted to user devices within the community of users (302). Many other parameters are also disclosed above and can be included within this list. Via an application plug-in and based on the parameter, the system presents a notice to a first user device of the application (304) and receives an identification of a second user of the application (306). The system performs a transaction via the application plug-in between the first user device and second user device associated with the second user (308).

As noted above, the transaction may also not require a second user but may be a transaction such as a donation to a disaster fund that is associated with the community of users and/or a parameter associated with the application such as the broadcast station in some way. In one example, assume a community of users includes all those listening to a Haiti radio station. Assume an earthquake then hits Haiti. The system could define a sub-community of users that are located within the United States. The system could then offer an opportunity for those users to make a donation to a disaster relief fund. Thus, such a sub-community could be established and identified on a short term basis or can be chosen according to an immediate event or need.

Another example would be using an Orbitz plug-in. Say they want to connect or sell airline services to people in New York that want to fly to Haiti. In this scenario Orbitz would include a plug-in to the application. User information can be utilized that they are Haitian and they are in NY. So the system activates the Orbitz plug-in and offers him a flight to Haiti. The user then interacts with the plug-in to provide the necessary information about the flight to Haiti, costs, dates, times etc. The plug-in can interact with Orbitz servers to accomplish the reservation of a flight. The user in this case does not need to add his credit card information because the plug-in can communicate with the application to obtain the payment information. The SDK is what enables this to all happen. The SDK is like a container for the various plug-ins and also has some functionality for features like a user search. Thus a user can search for the various plug-ins in an application of they are looking for. The SDK can provide like an electronic wallet functionality. The SDK will be middleware and will be open to the public for use and development of a variety of plug-ins and provides a connection between the application and some outside entity functionality.

Examples within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can apply to streaming audio in different languages and can apply to hearing impaired users. Various modifications and changes may be made to the principles described herein without following the example embodiments and applications illustrated and described herein, and without departing from the spirit and scope of the disclosure.

1. A method comprising:
receiving a parameter associated with an application which connects user devices with streaming audio, the parameter being data associated with a community of users of the application;
via an application plug-in and based on the parameter, presenting a notice to the first user device of the application;
receiving an identification of a second user of the application, the second user being in another country from the first user; and
performing a transaction via the application plug-in between the first user device and a second user device associated with the second user.

2. (canceled)

3. (canceled)

4. The method of claim 1, wherein the first user and the second user are one of: part of a community of users, members of a same family, friends, members of the community of users but associated via different hierarchical layers of the community, and defined in separate sub-communities by an event associated with the community.

5. The method of claim 1, wherein the data is one of a listener of the audio system, an ethnicity of a broadcast provided through the application, a location, a purchasing history of the first user or the second user, a time of day, and a location of an agent associated with a money transfer.

6. The method of claim 1, wherein the transaction comprises a money transfer from the first user and the second user.

7. The method of claim 1, wherein the transaction comprises one of a purchase of an item by the first user for the second user, a communication between the first user and the second user, and a social media communication between the first user and the second user.

8. The method of claim 1, wherein the transaction is performed within the application and not via a separate service from the application.

9. The method of claim 1, wherein a charge for the transaction is applied to the first user based on a parameter.

10. The method of claim 9, wherein the parameter is one of: a closeness value between the first user and the second user, a community relationship between the first user and the second user, a value related to how much the first user or the second user uses the application.

11. A method comprising:
receiving a parameter associated with an application that connects user devices with steaming audio, the parameter being data associated with a community of users of the application and an event affecting at least some of the community of users;
via an application plug-in and based on the parameter, presenting a notice to a first user device of the first user of the application, the notice associated with a transaction related to one of the community of users and a second user of the community of users that is in a different country from the first user;
receiving an interaction with the notice from the first user of the application; and
performing a transaction via the application plug-in based on the interaction.

12. The method of claim 11, wherein the interaction is a donation.

13. The method of claim 11, wherein the interaction is a social media communication between the first user and the second user in the community of users.

14. The method of claim 11, wherein the interaction is a money transfer from the first user to the second user of the community of users.

15. A system comprising:
a processor; and
a computer-readable medium storing instructions which, when executed by the processor, cause the processor to perform operations comprising:
receiving a parameter associated with an application that connects user devices with steaming audio, the parameter being data associated with a community of users of the application, transaction history of a first user of the application;
via an application plug-in and based on the parameter, presenting a notice to the first user device of the application;
receiving an identification of a second user of the application, the second user being in another country from the first user; and
performing a transaction via the application plug-in between the first user device and a second user device associated with the second user.

16. (canceled)

17. (canceled)

18. The system of claim 15, wherein the first user and the second user are one of:
part of a community of users, members of a same family, friends, members of the community of users but associated via different hierarchical layers of the community, and defined in separate sub-communities by an event associated with the community.

19. A system comprising:
a processor; and
a computer-readable medium storing instructions which, when executed by the processor, cause the processor to perform operations comprising:
receiving a parameter associated with an application that connects user devices with steaming audio, the parameter being data associated with a community of users of the application and an event affecting at least some of the community of users;
via an application plug-in and based on the parameter, presenting a notice to a first user device of a user of the application, the notice associated with a transaction related to one of the community of users and a second user of the community of users, the second user being in another country from the first user;
receiving an interaction with the notice from the first user of the application; and
performing a transaction via the application plug-in based on the interaction.

20. The system of claim 19, wherein the transaction is one of a donation, a payment from the first user to the second user, a social media communication between the first user and the second user.
